(19) United States
(12) Patent Application Publication
(10) Pub. No.: US 2012/0185260 A1
(43) Pub. Date: Jul. 19, 2012

(54) SYSTEM AND METHOD FOR INSPECTING EQUIPMENT AND ESTIMATING REFURBISHMENT COSTS THEREOF

(76) Inventors: Francis Perez, Holmdel, NJ (US); Franco Avella, Staten Island, NY (US); Giuliano Avella, Staten Island, NY (US)

(21) Appl. No.: 13/294,747

(22) Filed: Nov. 11, 2011

Related U.S. Application Data
(60) Provisional application No. 61/433,549, filed on Jan. 18, 2011.

(51) Int. Cl. G06Q 99/00

(52) U.S. Cl. 705/1.1

(57) ABSTRACT

Systems and methods for inspecting equipment and generating systematic estimates associated with the refurbishment, repair or replacement of damaged portions thereof.

### FIELD OF THE INVENTION

The invention relates to systems and methods for inspecting equipment and generating estimates associated with the refurbishment, repair or replacement of damaged portions thereof.

### BACKGROUND

Returned or in-service equipment such as off-lease equipment must be inspected to determine if any damage has been sustained. In particular, the determination must be made as to whether the equipment has been damaged, the particular components that have been damaged, the cost of repairing or replacing the damaged components, the allocation of that cost between the lessor/lessee of the equipment and so on. Presently, this process is performed by a skilled professional inspecting equipment, determining the damage to the equipment, determining the parts that must be replaced or repaired to fix the damage, determining the cost associated with this replacement or repair and so on.

### SUMMARY

Various deficiencies of the prior art are addressed by the present invention of a system adapted to provide an intelligent user interface enabling inspection and damage assessment of equipment by relatively unskilled personnel.

One embodiment of the invention provides a hand held device such as a tablet computer for displaying imagery associated with the equipment, wherein the imagery may be manipulated to rotate, zoom in, select and otherwise identify any portions of the equipment (and any subcomponents) that should be repaired or replaced. The various identified portions and subcomponents to be repaired or replaced are communicated to a server which responsively determines the necessary parts list, parts cost, labor cost, time to repair/replace and so on associated with the job of refurbishing the equipment.

The server function may be implemented as a local server proximate to one or more handheld devices, remote server access via the Internet and so on. One embodiment comprises a software as a service (SAAS) function in which the various customers using the handheld devices upload data to one or more servers for subsequent processing. Included in this processing may be specific determinations as to cost, the party that should bear the cost such as allocated by an equipment lease or other agreement, reporting functions and so on. Generally speaking, various embodiments of the invention are computer implemented using handheld devices, servers, communications devices and so on.

A method according to one embodiment comprises, for each of a plurality of portions of equipment to be inspected according to a defined sequence, performing the steps of displaying, via a display on a portable user device, an image of the equipment portion; displaying, via the display and in response to user input to the portable user device, one or more elements or sub-elements within the equipment portion; in the case of user input indicative of one or more damaged elements or sub-elements, displaying a user prompt requesting the user to photograph the one or more damaged elements or sub-elements; and including, in repair/replace list adapted for propagation to a server, identification and photographs of damaged elements or sub-elements.

### BRIEF DESCRIPTION OF THE DRAWINGS

The various embodiments discussed herein can be readily understood by considering the following detailed description in conjunction with the accompanying drawings, in which:

FIG. 1 depicts a high-level block diagram of an exemplary system for inspecting equipment and generating estimates associated with the refurbishment, repair or replacement of damaged portions thereof;

FIG. 2 depicts a high-level block diagram illustrating one embodiment of a user device suitable for use in the system of FIG. 1;

FIG. 3 depicts a flow diagram of a method for inspecting equipment according to one embodiment;

FIG. 4 depicts a flow diagram of a method for generating inspection validation imagery;

FIG. 5 depicts an exemplary display image suitable for use within the context of the present embodiments;

FIG. 6 depicts an exemplary user interface display screen suitable for use within the context of, illustratively, a server/adjuster mode of operation;

FIG. 7 depicts a flow diagram of a method for validating inspection data; and

FIG. 8 depicts a high-level block diagram of a computer suitable for use in performing functions described herein.

To facilitate understanding, identical reference numerals have been used, where possible, to designate identical elements that are common to the figures.

### DETAILED DESCRIPTION OF THE INVENTION

Various embodiments with be described within the context of a system in which a user device such as a tablet computer is used to guide a user through the process of inspecting equipment for worn or damaged parts, identifying a cause of such wear or damage and allocating a responsibility for paying to repair or replace the worn or damaged parts. In the port/terminal/shipping/intermodal industry, such inspection of a shipping container or a trailer chassis (used to receive the container for subsequent delivery via truck) results in a Terminal interchange receipt (TIR).

In essence, a virtual TIR (VIR) is provided which may also be used as an inventory tool, so that the drivers/machine operators can build virtual chassis and container stacks, so that they always know where their equipment is located within their yard. The VIR in a basic form provides similar data as a TIR; in other forms the VIR provides other modes to choose from.

Substantially all of the information that gets entered into the VIR is available to view in on a website, which can be accessed by use of a username and password. The information can be uploaded to the site either wirelessly or manually synced up to the server using a USB connection from PC to tablet. The tablet may comprise a 7 inch, 10 inch or other size Android, Apple or other operating system-based device with a built in camera for image recognition and damage documentation. The device may be encased in a water proof, durable custom case, with or without a strap handle for ease of portability.

In one embodiment, when the VIR powers on an animated VIR image is displayed during the boot up process. After the tablet boots up, in an intermodal embodiment, the VIR program displays one or more rotating 3D images. Image one may be of a container, image two may be of a chassis, and image three may be of a stack of containers. When one of these images is touched it turns red (or is shaded differently) and/or selected, when touched again it turns green (or is shaded differently) and/or selected.

When a chassis is selected, the user is asked to specify the size/type (40-45 ft-20 ft slider). Once selected the first screen that appears is the image recognition screen by VIN/license plate/make/owner of chassis. This step also forces the client to verify the license plate associated with the unit number from the master list once the user reaches the back bolster. Once the user performs the image recognition step, the user can commence with the chassis inspection. The inspection is broken down into sections, which are in the order of a proper inspection procedure. The user begins the inspection at a predefined point, such as the front bolster of a chassis. Once the user finishes inspecting a section, the screen will pan/transition to the next section of the chassis and selectable zones, The user continues walking to, illustratively, the right side of the equipment, inspecting as he or she walks along from front to back, then finishing back at the front bolster.

The chassis is displayed on the handheld device as, illustratively, a blue, computer generated image consisting of selectable zones. When a selectable section of the zone is touched, the corresponding portion of the display turns red. Once touched again, the zone will open to show the various components within the zone. Once a component is selected, the user can then select the type of damage the component has sustained by interacting with a drop down menu including various types of damage codes. Once the inspection of the chassis is complete, the user can send a hard copy to a printer to give to other personnel. The printed out receipt will also include the cost of the damages by referencing a tariff sheet with the prices of parts and labor.

All the information that is collected from the VIR is uploaded wirelessly, or synched up to an online database. This database can be accessed, and the information viewed or edited depending on the rights that are granted to the viewer of the information. This information that is uploaded to the database can be downloaded into existing depot backend systems such as those manufactured by John Evans, Inc. or Depot Systems, Inc. In this manner, any existing depot system may be augmented with the ability to use the specific handheld devices constructed according to the various embodiments within the context of existing backend systems.

Various embodiments will be described primarily within the context of a system in which an inspector using a handheld device such as a smart phone or tablet device performs a detailed, sequentially ordered and documented inspection process of a piece of equipment. The inspection data collected using the handheld device is validated and processed by a server in conformance with the requirements of the equipment owner, insurance carrier and the like. A smart phone or tablet platform may comprise any such platform including those enabled by any of the various smartphone operating systems, including those associated with Blackberry, iPhone, Droid, Pixie, Windows mobile and so on. However, it will be appreciated by those skilled in the art that the particular platform and/or operating system may be adapted in response to the various teachings described herein.

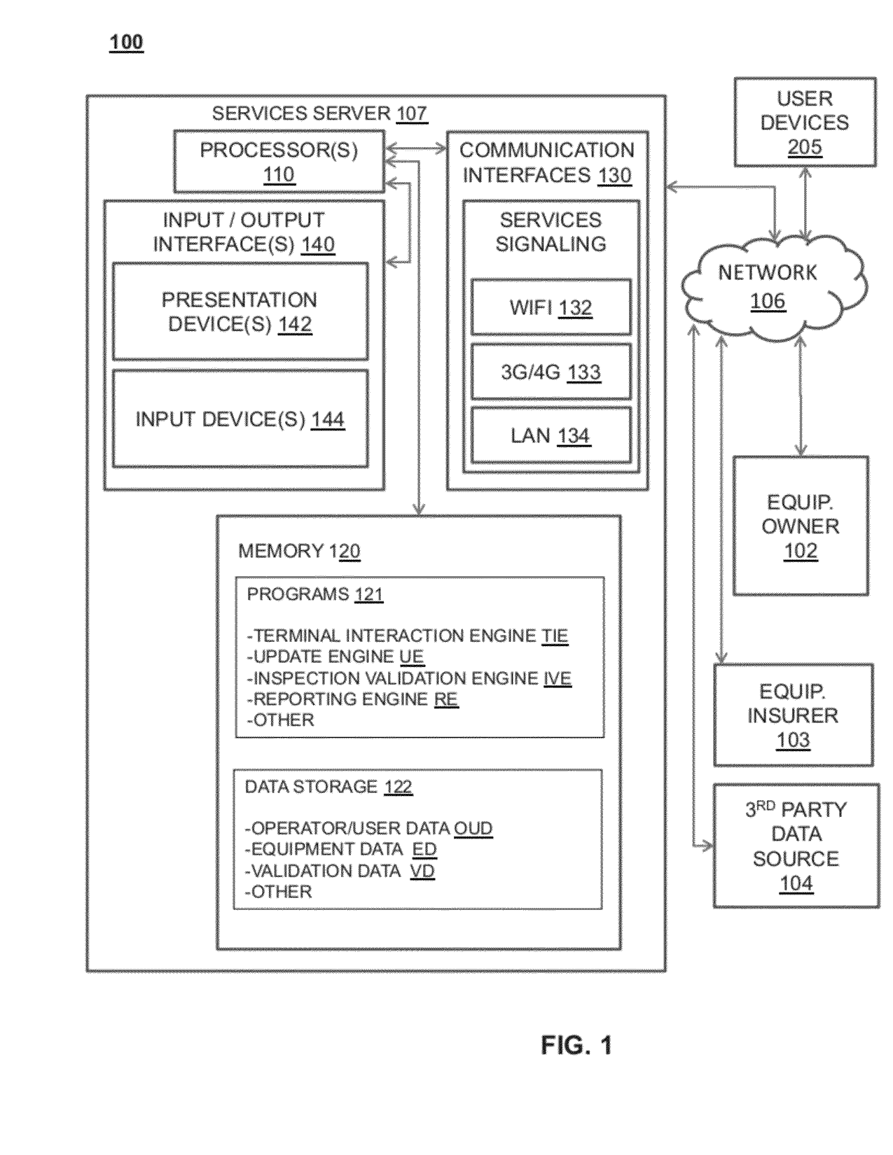

FIG. 1 depicts a high-level block diagram of an exemplary system for enabling inspecting returned equipment and generating estimates associated with the refurbishment, repair or replacement of damaged portions thereof. In particular, FIG. 1 is primarily directed toward illustrating server-side processing functions associated with the various embodiments.

As depicted in FIG. 1, exemplary system 100 includes one or more user devices 205, a network 106 and a services server 107. In various embodiments, exemplary system 100 further includes one or more of an equipment owner server 202, an equipment insurer server 203 and 3^{rd} party data source server 204.

Network 106 may comprise one network or multiple networks. Moreover, network 106 may include Wi-Fi, WiMAX, 3G and or 4G wireless network capabilities to communicate with wireless user devices 205. Portions of network 106 may comprise optical, satellite or other network infrastructure to support back channel communications between the services server 207, equipment owner server 202, equipment insurer server 203 and/or 3^{rd} party data source server 204.

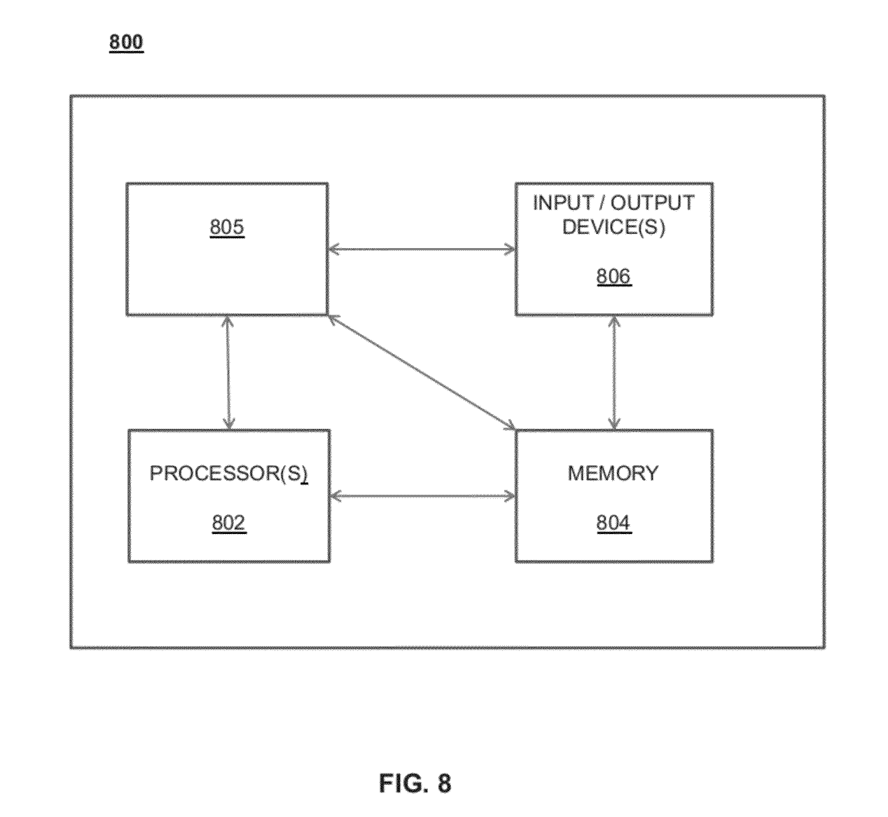

A specific hardware implementation associated with the services server 107 will be discussed in detail, However, general computing infrastructure such as discussed with respect to the services server 107, as well as the generic infrastructure discussed below with respect to FIG. 8 may be used to implement any of the functions associated with the services server 107, equipment owner server 202, equipment insurer server 203 and/or 3^{rd} party data source server 204 and user devices 205.

The server-to-server 107 includes one or more processors 110, a memory 120, communications interfaces 130, and input/output (VO) interface 140. The processor 110 is coupled to each of memory 120, communication interfaces 130, and I/O interface 140.

The processor 110 is configured for controlling the operation of services server 107, including operations to interact with the various user devices, as well as provide to the user devices 205 equipment inspection and rendering data suitable for use within the context of the equipment inspection and repair/replace cost estimation methodologies described herein.

The memory 120 is configured for storing information suitable for use in supporting the various inspection and estimating functions described herein. Memory 120 may store programs 121, data 122 and the like. While memory 120 is depicted as a singular memory element storing programs 121 and data 122, it will be appreciated by those skilled in the art that memory 120 may be comprised of multiple types of memory including static memory, dynamic memory, mass storage devices, local memory, remote memory and the like as will be familiar to those skilled in the art.

Stored programs 121 may include one or more of a terminal interaction engine (TIE), an inspection validation engine (IDE), a reporting engine (RE) and/or other programs suitable for use by the services server 107 in supporting the inspection/estimation methodologies and other methodologies and systems discussed herein. Stored data 122 may include operator/user data (OUD), equipment data (ED), validation data (DD) and/or other data suitable for use by the services server 107 in supporting the inspection/estimation methodologies and other methodologies and systems discussed herein.

The terminal interaction engine (TIE) performs various functions associated with interactions between the user devices 205 and the services server 107, such as establishing or tearing down sessions between the services server 107, transmitting data there between via one or more channels supported by the network 106 and so on. Data transmissions from the user devices 205 to the services server 107 include equipment inspection and/or estimation data, reports, exceptions and the like. Such data transmissions may also include operator data updates such as revised lists of authorized inspectors, qualifications of new or existing inspectors and so on. Data transmissions from the services server 107 to the user devices 205 may include operator/user database updates, inspection and image database updates, equipment database updates, software updates, procedural updates and so on as discussed herein.

The update engine (UE) performs various functions associated with ensuring that the operator/user data OUD, equipment data ED and validation data VD is current. The update engine may interact with any or all of the equipment owners 102, equipment insurers 103 and 3rd data sources 104 to acquire new or updated information pertaining to equipment to be inspected, operators using the system, authorization levels of inspectors/users associated with operators, image/inspection changes driven by new types of equipment or modifications to existing equipment and so on. The update engine may interact with the user devices 205 either directly or via the terminal interaction engine to push equipment, inspection, rendering, validation, operator, inspector/user and/or other data to the user devices 205 as appropriate.

The inspection validation engine (IVE) operates to validate inspection/estimation data received from the operator. For example, in various embodiments, the validation engine ensures that the timestamps, location stamps and so on associated with required imagery correlate to the time/location information associated with the equipment being inspected. The inspection validation engine may flag data within the particular inspection report, may generate a validation report associated with all or some of the inspection reports, may identify inspection reports that are deficient in some manner and return those immediately to the operator and/or perform other functions.

In one embodiment, the validation engine compared timestamps and/or location stamps of each of the imaged portions of a particular piece of inspected equipment to determine if the time and/or location stamps are reasonably similar to each other. Any deviations may be indicative of an improperly performed or falsified inspection.

In one embodiment, the validation engine examines RFID information or other identifying information associated with the equipment to be inspected to ensure that the piece of equipment inspected is in fact the equipment represented as being inspected within the inspection report and so on. If equipment associated with a particular owner or insurer is normally located in the designated area of an inspection yard (e.g., a loading dock, warehouse, yard and the like), then the RFID tag or other identifying information of the equipment to be inspected may be correlated to the location stamps of the inspection images to determine if the location stamp matches the designated area.

In one embodiment, the validation engine identifies inspector/user exceptions, nonstandard results and or other anomalies identified within inspection reports. For example, the inspector may have skipped or been unable to inspect a portion of the inspected equipment, may have failed to image a portion of inspected equipment, may have implemented a quick repair of something such that the inspection report should be changed and so on.

The reporting engine (RE) aggregates the various inspection reports and/or validation reports. Generally speaking, the reporting engine operates to provide inspection information, validation information and/or other information to the equipment owners 102 and/or equipment insurers 103. This information may also be provided to the operators of the yard where equipment is inspected.

The communication interfaces 130 include the necessary networking/communications capability to communicate with network 106 and or directly with various other entities as discussed herein. It will be appreciated that fewer or more, as well as different, communications interfaces may be supported. As depicted herein, communication interfaces 130 include any or all of hardware/software functionality associated with network services signaling, such as Wi-Fi or WiMAX networks 132 (e.g., 802,11x and the like), 3G and/or 4G mobile networks 133, and/or wired or wireless local area networks (LANs) 134 (such as Ethernet, Gigabit Ethernet and the like) for supporting data/services signaling between the services server 107 and external communications and services infrastructure/network 106.

In various embodiments, the user devices 205 operate in a substantially standalone manner to perform the various functions described herein with respect to the inspection and cost estimation functions described herein. In this embodiment, the user device 205 guides an inspector through an equipment inspection process, optionally validates some or all of the data gathered thereby, and interacts with the services server 107 to convey such data to the services server 107.

In various embodiments, the user devices 205 and services server 107 implement a software as a service (SAAS) model wherein some or all of the software instantiated within the user device 205 is incrementally provided by the services server 107 in real-time as the equipment inspection/estimation process is proceeding.

In various embodiments, the user devices 205 and services server 107 may be in constant communication to transmit/update inspection data passed therebetween in substantially real time. In various embodiments, the user devices 205 and services server 107 communicate only periodically to transmit/update Inspection data, such as at the end of each equipment inspection, once or twice a day and so on.

Although primarily depicted and described herein with respect to specific types, numbers, and arrangements of devices, networks, and other related elements, it will be appreciated that any other suitable types, numbers, and/or arrangements of devices, networks, and/or other related elements may be used for enabling the various functions discussed herein with respect to FIG. 1.

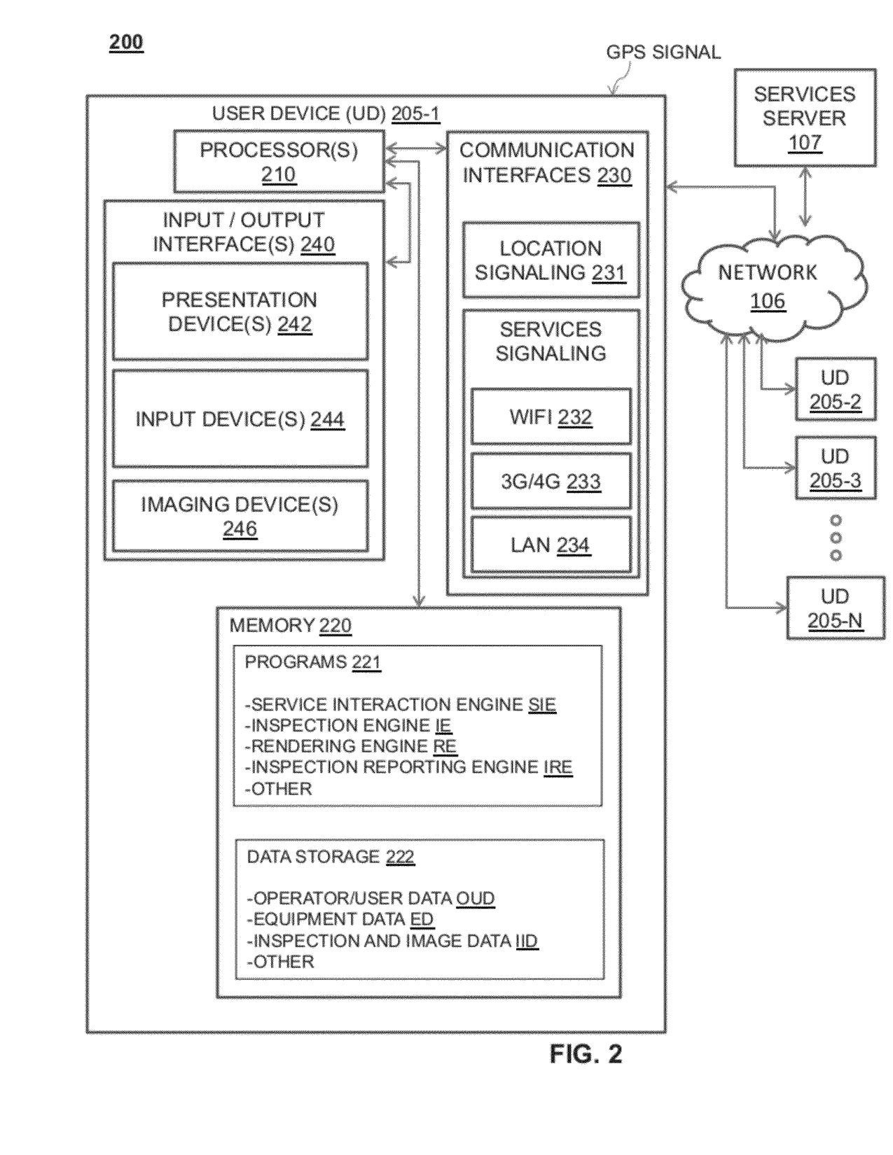

FIG. 2 depicts a high-level block diagram of an exemplary system for enabling inspecting returned equipment and generating estimates associated with the refurbishment, repair or replacement of damaged portions thereof. In particular, FIG. 2 is primarily directed toward illustrating client-side or user device processing functions associated with the various embodiments.

As depicted in FIG, 2, exemplary system 200 includes a plurality of user devices 205 denoted as user devices 205-1, 205-2 and so on up to 205-N (collectively user devices 205), a network 106 and a services server 107. The operations of the network 106 and services server 107 of FIG. 2 are substantially similar to corresponding network 106 and services server 107 described above with respect FIG. 1.

As depicted in FIG. 2, a user device 205 includes one or more processors 210, a memory 220, communications interfaces 230, input-output (110) interface(s) 240. The processor 210 is coupled to each of memory 220, communication interfaces 230, and I/O interfaces 240. The I/O interfaces 240 includes or is coupled to one more presentation devices 242 for presenting information on user device 205 (e.g., mobile smartphone or tablet display screen), one or more user input devices 244 (e.g., mobile smart phone or tablet touch screen or keypad input devices) for enabling user control of user device 205, and one or more imaging devices 246 (e.g., mobile smart phone or tablet camera or other imaging device).

The processor 210 is configured for controlling the operation of user device 205 to provide the various inspection, estimation,, validation update and related functions as described herein.

The memory 220 is configured for storing information suitable to provide the various inspection, estimation, validation update and related functions as described herein. The memory 220 may store programs 221, data 222 and the like. While memory 220 is depicted as a singular memory element storing programs 221 and data 222, it will be appreciated by those skilled in the art that memory 220 may be comprised of multiple types of memory including static memory, dynamic memory, mass storage devices, local memory, remote memory and the like as will be familiar to those skilled in the art.

Stored programs 221 may include one or more of an inspection engine (IE), rendering engine (RD), services interaction engine (SIE), inspection reporting engine (IRE) and/or other programs suitable for use by the user device 205 in supporting the inspection/estimation methodologies and other methodologies and systems discussed herein. Stored data 222 may include operator/user data (OUD), equipment data (ED), inspection and image data (HD) and/or other data suitable for use by the user device 205 in supporting the inspection/estimation methodologies and other methodologies and systems discussed herein.

The services interaction engine (SIE) performs various functions associated with interactions between the user devices 205 and the services server 107, such as establishing or tearing down sessions between the services server 107, transmitting data therebetween via one or more channels supported by the network 106 and so on. Data transmissions from the user devices 205 to the services server 107 may include equipment inspection and/or estimation data, reports, exceptions and the like. Such data transmissions may also include operator data updates such as revised lists of authorized inspectors, qualifications of new or existing inspectors and so on. Data transmissions from the services server 107 to the user devices 205 may include operator/user database updates, inspection and image database updates, equipment database updates, software updates, procedural updates and so on as discussed herein.

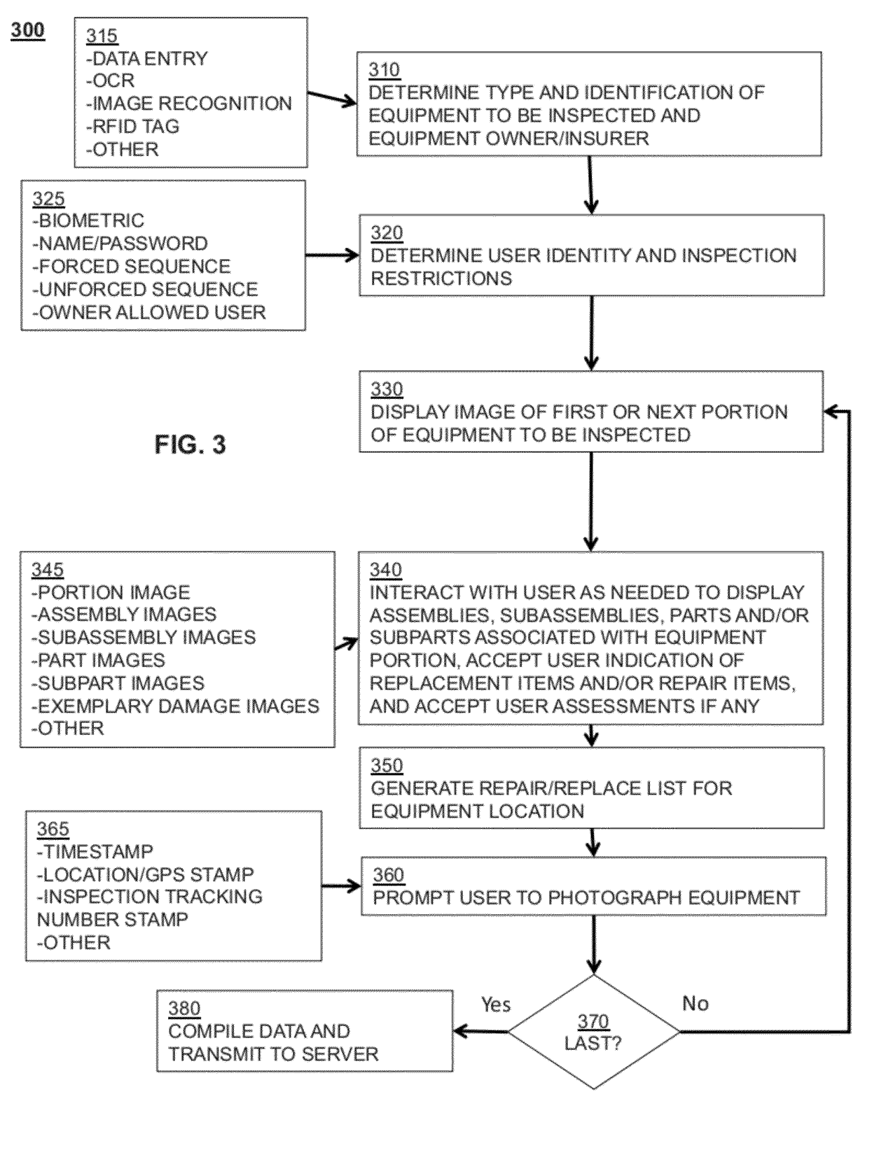

The inspection engine (IE) utilizes data from data storage 222 to perform various functions that guide an inspector/user through the inspection of a piece of equipment and validate the inspection. Various embodiments of these functions will be described in more detail below with respect to FIGS. 2 and 3.

The rendering engine (RE) utilizes data from data storage 222 to provide accurate equipment imagery for presentation during equipment inspections.

The inspection reporting engine (IRE) organizes inspection related information for transmission to the services server 107, either directly or via the service interaction engine.

The communications interfaces 230 may include a location signaling interface 231 such as for receiving and/or processing global positioning system (GPS), mobile network location data or other location data suitable for use in determining the location of the user device 205.

The communication interfaces 230 include the necessary networking/communications capability to communicate with network 106 and or directly with various other entities as discussed herein. It will be appreciated that fewer or more, as well as different, communications interfaces may be supported. As depicted herein, communication interfaces 230 include any or all of hardware/software functionality associated with network services signaling for any or all of Wi-Fi or WiMAX networks to 32 (e.g., 802.11x and the like), 3G and/or 4G mobile networks to 33, and/or wired or wireless local area networks (LANs) 234 (such as Ethernet, Gigabit Ethernet and the like) for supporting data/services signaling between the user device 205 and external communications and services infrastructure/network 106. It will be appreciated that fewer or more, as well as different, communications interfaces may be supported.

The communications interfaces 230 include one or more services signaling interfaces such as a VVi-Fi or WiMAX interface 232, a 3G and/or 4G mobile network interface 233, and/or a 4G wireless interface 234 for supporting data/services signaling 126 between user device 205 and external communications and services infrastructure/network 106.

The I/O interface 240 provides an interface to the presentation device(s) 242, and the device(s) 244 and imaging device(s) 246 of user device 205.

The presentation device(s) 242 includes any presentation device suitable for use in presenting information, such as a display screen which may be used for displaying one or more of still imagery, video imagery, inspection instructions, virtual keypads and the like, as well as various combinations thereof.

The input device(s) 244 include any device suitable for enabling user input to the user device 205. For example, the user device(s) 244 may include any of touch screen based user controls, stylus-based user controls, a keyboard and/or mouse, voice-based user controls, and the like, as well as various combinations thereof.

Typical user presentation, input and control interfaces of various types of user devices 105, including the design and operation of such interfaces, will be understood by one skilled in the art. For example, within the context of a smart phone or tablet implementation of the user device 205, the presentation device 242 and input device 244 may be combined in the form of a touchscreen.

Although primarily depicted and described as having specific types and arrangements of components, it will be appreciated that any other suitable types and/or arrangements of components may be used for user device 200. The user device 200 may be implemented in any manner suitable for enabling the advertising presentation and transaction capability described herein.

Although primarily depicted and described herein with respect to specific types, numbers, and arrangements of devices, networks, and other related elements, it will be appreciated that any other suitable types, numbers, and/or arrangements of devices, networks, and/or other related elements may be used for enabling the various functions discussed herein with respect to FIG. 2.

FIG. 3 depicts a flow diagram of a method for inspecting equipment according to one embodiment. Specifically, the method 300 of FIG. 3 is suitable for use within the context of the user device 205 discussed above with respect to FIGS. 1-2. An inspector or user interacting with the user device 205 is guided through all of the steps necessary to achieve a thorough and accurate inspection of the equipment such that appropriate repair/replacement of worn or damaged parts may be effected. In addition, validation data is gathered during this inspection sufficient to give the equipment owner or insurer confidence in the accuracy of the inspection. In this manner, the flow of equipment requiring inspection/repair through a backyard, warehouse or other location may be dramatically increased by avoiding secondary inspections and the like.

At step 310, the type and identification of equipment to be inspected is determined. Optionally, the equipment owner and/or insurer associated with the equipment to be inspected is also determined. Generally speaking, equipment type, serial number and/or ownership may be established via a visual identification tag, a barcode or other marking, a radio frequency identification (RFD) tag, or some other means. Referring to box 315, the determination may be made by the inspector manually entering serial number data or other visible data via a keypad or other user input device, using optical character recognition (OCR) or image recognition to scan an image of the serial number data or other visible data, interacting with an RFID tag or using some other mechanism to establish the type and serial number associated with the equipment to be inspected.

At step 320, the identity of the inspector/user as well as any inspection restrictions associated with this inspector/user is determined. Referring to box 325, user identity may be determined with respect to biometric measurements (e.g., fingerprint scanning, retinal scanning and the like), user input of a name and password and the like. In addition, inspection restrictions may include particular forced sequences of inspections required for particular users based upon experience level and the like. More experienced users may be allowed to select a particular sequence of inspection. Additionally, owner-imposed restrictions may prevent some users from inspecting equipment associated particular owners, such as based on prior bad experiences with the users.

At step 330, an image of a first or next portion of the equipment to be inspected is displayed. For example, if a sequence of inspection steps contemplate 10 portions of the equipment to be inspected, an image of the first or next one of the 10 portions of the equipment is displayed so that the user/inspector is guided to the appropriate portion of the equipment.

At step 340, the user interacts with the displayed equipment portion as needed to further display assemblies, subassemblies and/or individual parts associated with the portion of equipment being inspected. Referring to box 345, display interaction contemplates user manipulation of a plurality of displayed images arranged and accessed in a hierarchical manner, which displayed images include the portion of equipment being inspected, any assembly within that portion, any subassembly associated with an assembly, any part associated with an assembly or subassembly, and/or any subpart associated with a part. In various embodiments, exemplary images of damaged assemblies, subassemblies, parts and/or subparts are provided to assist the inspector in assessing whether or not the repair/replacement is needed.

The user interaction at step 340 further includes user indication of which assemblies, subassemblies, parts and/or subparts associated with the equipment portion being inspected require replacement and/or repair. In addition, this user interaction may also include an assessment as to the likely cause of the damage, such as normal wear and tear, rough handling or abuse, poor maintenance, corrosion/damage due to weather or cargo spilling and the like.

At step 350, a repair/replace list is generated for the inspected equipment portion.

At optional step 360, the user is prompted to capture one or more digital images (still images or moving images) of the equipment portion, assembly, subassembly, part and/or subpart of the equipment portion being inspected. More or fewer images may be gathered based upon parameters defined by the equipment owner, insurer or yard operator. Referring to box 365, captured images may be associated with a timestamp, a location stamp, an inspection tracking number and the like, which data is useful in subsequently validating the accuracy and thoroughness of the inspection.

At step 370, a query is made as to whether the last portion of the equipment to be inspected has in fact been inspected. If the query is answered negatively, then the method 300 proceeds to step 330 where an image of the next portion of the equipment to be inspected is displayed.

At step 380, the inspection data is compiled and transmitted to the services server 107. In one embodiment, the compilation of inspection data and its transmission to the services server 107 occurs at the conclusion of inspection for each portion of the equipment. In other embodiments, inspection data is continuously transmitted to the services server 107.

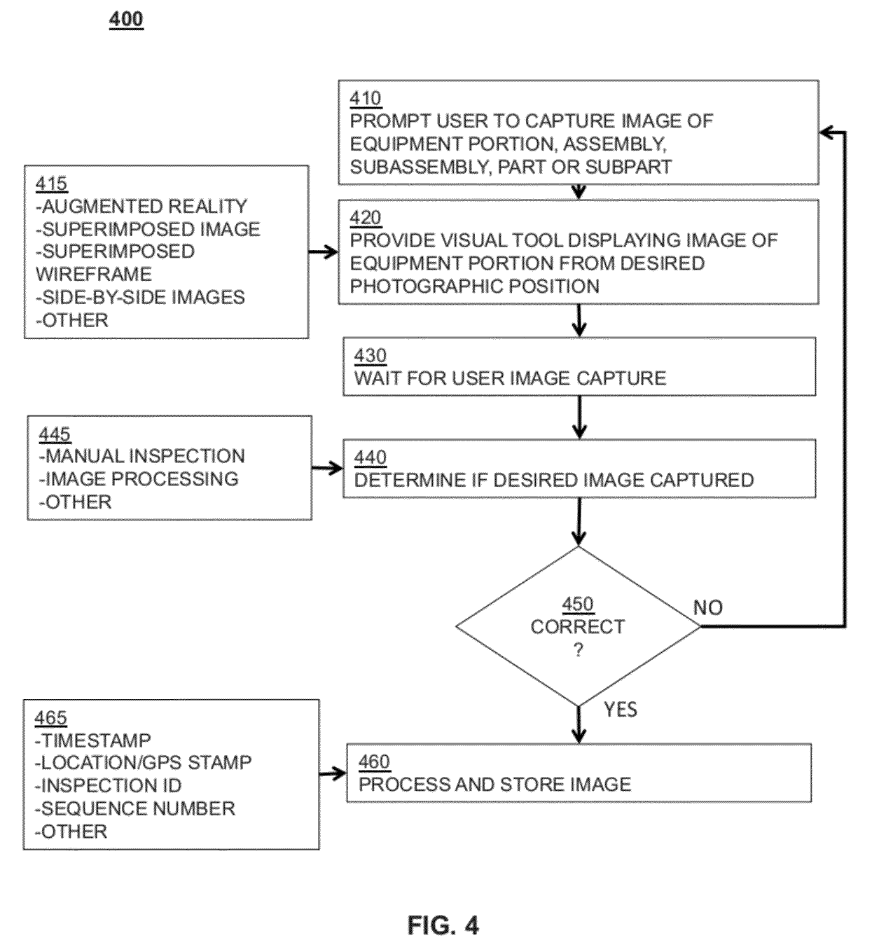

FIG. 4 depicts a flow diagram of a method for generating inspection validation imagery. Specifically, FIG. 4 depicts a method 400 suitable for capturing imagery associated with an equipment portion, assembly, subassembly, part and or subpart such as discussed above with respect to step 340 of the method 300 of FIG. 3.

At step 410, the user is prompted to capture image of an equipment portion, assembly, subassembly, part or subpart.

At step 420, a visual tool displaying an exemplary image to be captured is provided to the user, Specifically, exemplary image is displayed depicting any of a desired photographic position, a desired framing or other characteristic associated with an image to be captured to thereby help the user capture the appropriate image. Referring to box 415, in one embodiment the visual tool may comprise an augmented reality tool in which graphical data is superimposed upon or integrated with captured digital imagery, In various embodiments, the visual tool comprises an exemplary sample or wireframe image superimposed upon are integrated with captured digital imagery. In various embodiments, the exemplary image is displayed side-by-side with captured digital imagery.

At step 430, the method 400 waits for the user to capture an image.

At step 440, a determination is made as to whether the desired image has been captured. Referring to box 445, a determination is made by manual inspection of the captured imagery by the user, by image processing techniques to provide automatic or semiautomatic validation of the image and/or other techniques.

At step 450, a query is made as to whether the correct image has been captured by the user. If the query is answered negatively (e.g., a manual or automatic image comparison at step 440 indicates that the desired image was not captured), then the method 400 proceeds to step 410 where the user is again prompted to capture the desired image.

At step 460, the captured image is processed and stored at the user device 205. Referring to box 465, one or more of a timestamp, location stamp, inspection identifier, sequence number or other data element is associated with the stored image for subsequent processing by, illustratively, validation mechanisms within the user device 205 or services server 107.

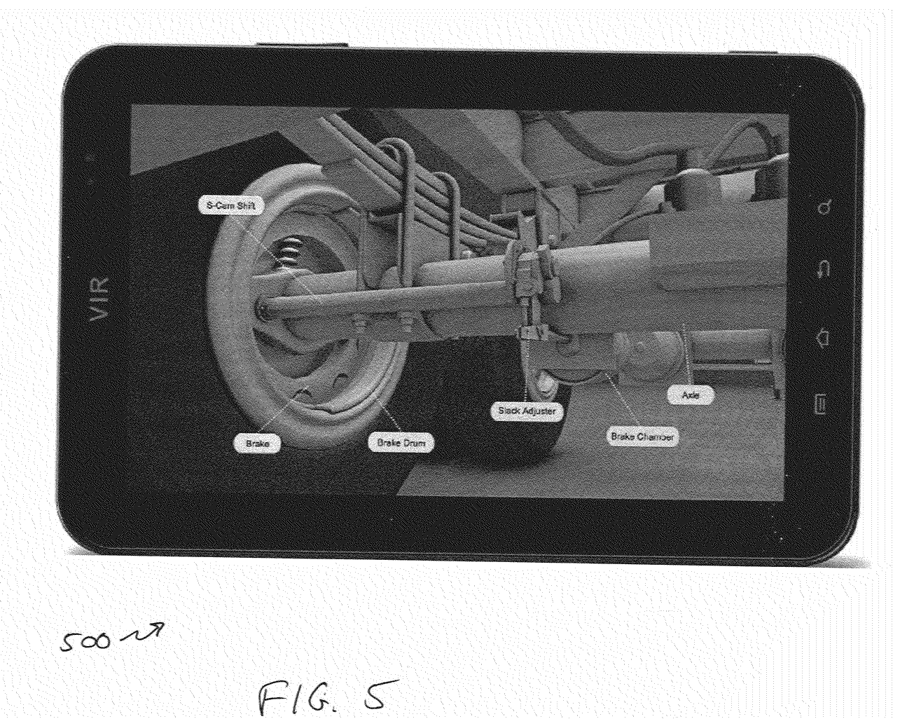

FIG. 5 depicts an exemplary display image suitable for use within the context of the present embodiments. Specifically, FIG. 5 depicts a graphical imagery representing an undercarriage portion of a truck as seen from a particular vantage point. As shown and labeled herein, various elements and subelements to be inspected are visible and labeled, such as a Break, Brake Drum, S-Cam Shift, Slack Adjuster, Rake Chamber, Axle and so on (various labels have been omitted for clarity).

In one embodiment, imagery such as depicted in FIG. 5 is displayed for the user within the context of user interaction adapted to identify damaged or worn elements or subelements. If a particular element or sub element appears to be damaged or worn in some manner, the user may touch the portion of the display screen proximate the damaged element or sub element, In one embodiment, a more detailed imagery of the element or sub element is responsibly displayed. In another embodiment, the color for shading of the damaged element or sub element changes, such as from green to red, from light gray to dark gray or crosshatched and so on.

In one embodiment, imagery such as depicted in FIG. 5 is displayed for the user within the context of a prompt to capture an image of equipment being inspected. For example, the image may be displayed as part of a prompt to the user to capture a digital image of the equipment from a particular vantage point; namely, the same vantage point of the displayed imagery.

It will be appreciated by those skilled in the art and informed by the present teachings that the specific vantage point of equipment being inspected, the specific elements depicted in the image and so on are adapted according to portion of equipment being inspected, the element or sub element of that portion and so on.

Various embodiments contemplate approximately 20 main display windows or views of a piece of equipment (or portions thereof) to be inspected. Each window is divided into a plurality of zones such that user activation or touch proximate a zone results in the display of a sub window including equipment elements associated with the activated zone. In addition, navigation between display windows is facilitated by “next” and “last” virtual buttons.

As an example of one embodiment of the user interface, equipment such as a chassis or container is initially displayed in its entirety. User manipulation such as swiping causes the displayed equipment to rotate about an axis such that a desired portion of the equipment is visible, For the use manipulation causes the rotation to stop. The user may tentatively select various portions of the displayed equipment for further displayed by running a finger or stylus over displayed equipment.

When a window region is selected such as by tapping upon it with one's finger or stylus, a display window associated with the selected region is then presented to the user. That is, a portion of a top level hierarchical image is selected by the user and, in response, the user device displays the next lower hierarchical image associated with the selected image portion. In this manner, a user may traverse multiple hierarchical levels of images associated with the equipment, manipulate imagery at each hierarchical level and generally navigate in a manner enabling rapid identification of equipment portions, assemblies, subassemblies, parts and/or subparts for inspection purposes.

Portions or zones of a window associated with no damage are highlighted by a first color (e.g., green), while portions or zones of a window associated with assemblies, subassemblies, parts and/or subparts exhibiting damage are highlighted by a second color (e.g., red). Thus, as user inspection of the equipment progresses, equipment portions, assemblies, subassemblies, parts and/or subparts found to be damaged in some manner are identified as such and further display windows associated with those damaged elements will be highlighted according to the second color. In one embodiment, the first color is used to highlight all windows until such time as a damaged element associated with a window is found. In one embodiment, highlighting is only provided where elements are found to be damaged (in which case second color highlighting is used) or where elements are found to be not damaged (in which case first color highlighting is used).

In the case of the various inspection sequence as described herein, where the specific sequence of inspection steps necessary to be taken by the inspector are predefined, the display windows associated with those inspection steps are also displayed according to the predefined sequence. Moreover, in various embodiments, user manipulation of the displayed windows is constrained in that the user may not move to a different portion of the equipment until inspection steps associated with the present portion of the equipment being inspected have been satisfied. That is, the user may only interact with hierarchical imagery associated with the equipment portion being inspected at this time.

Various embodiments provide nationwide fleet monitoring capabilities to owners and operators. For example, various embodiments provide live or near real-time communication between user devices such as tablets and local or remote servers and/or cloud-based service providers and databases.

In various embodiments, data security checkpoints are provided throughout the process, Photographic evidence for all major damage may also be provided in substantially real time to enable rapid repair/replace decisions and related cost allocation decisions by insurance adjusters and the like. Further, real-time tariff updates are provided via different embodiments.

In various embodiments, three modes of operation are provided; namely, gatekeeper mode, estimator mode and surveyor/adjuster mode. In gatekeeper mode, a user interacts with the service provider via a user device to identify and/or log received equipment to be inspected, identify and/or log inspected equipment to be repaired, identify and/or log repaired equipment to be released and so on. In estimator mode, and estimator interacts with the service provider via the user device to perform the various estimation functions described herein. In surveyor/adjuster mode, a surveyor or adjuster monitoring or auditing the output of one or more inspectors interacts with the service provider via the user device or another computing device to review and/or audit the provided estimates.

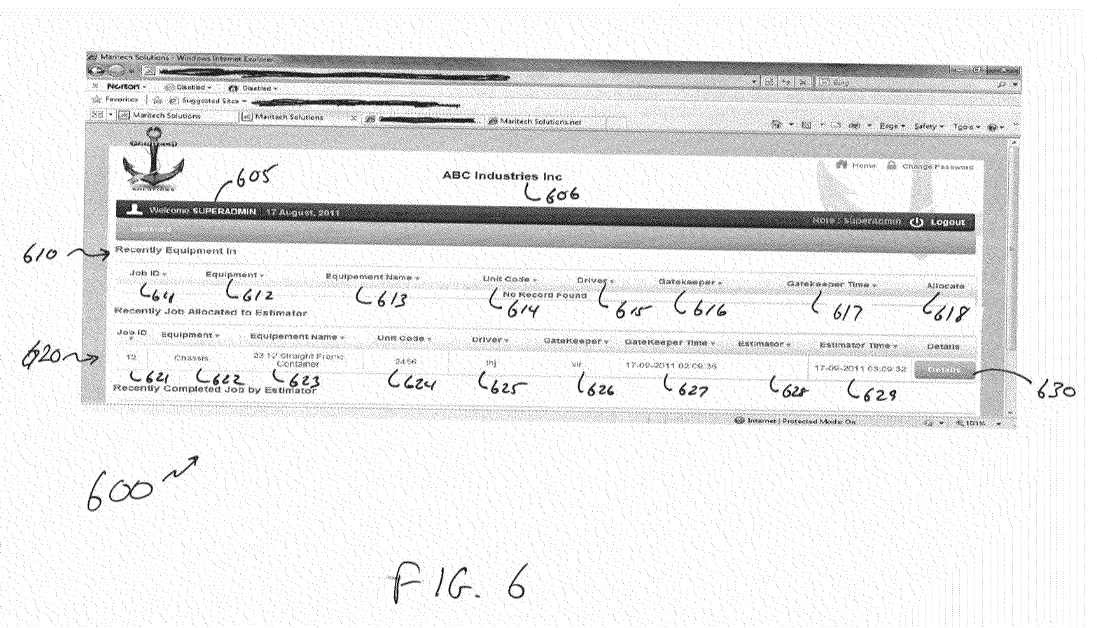

FIG. 6 depicts an exemplary display image suitable for use within the context of the present embodiments. Specifically, FIG. 6 depicts an exemplary user interface display screen suitable for use within the context of, illustratively, a server/adjuster mode of operation. The imagery depicted in FIG. 6 may be displayed to the user via the tablet computer or other computing device via a browser window as depicted, or some other display mechanism.

In particular, a user interface display screen 600 as depicted in FIG. 6 is provided via a World Wide Web (WWW) Internet browser communicating with a remote server. The user interface display screen 600 is adapted for use by an administrator 605 (e.g., SUPERADMIN) associated with a company 606 (e.g., ABC Industries, Inc.).

In addition to various standard data fields which are not discussed herein, the user interface display screen 600 includes a first data set 610 associated with recently received equipment. The first data set 610 is depicted as including a plurality of data fields, illustratively a job ID field 611, an equipment field 612, an equipment name field 613, a unit code field 614, a driver field 615, a gatekeeper field 616, a gatekeeper time field 617 and an allocate field 618.

Data within these various fields is associated with particular pieces of equipment that have been inspected. The job ID field 611 may be used to associate a particular job number with the inspection of a particular piece of equipment. The equipment field 612 and/or equipment name field 613 may be used to identify the equipment inspected as part of the job. The unit code field 614 may be used to identify worn or damaged parts that need repair or replacement according to an industry standard format. The driver field 650 may be used to identify the driver delivering equipment to be inspected. The gatekeeper field 616 may be used to identify the person receiving the equipment to be inspected. The gatekeeper time field 617 may be used to identify the date/time the equipment was received. The allocate field 618 may be used to identify the party or parties to whom a cost avocation for repair/replacement of worn or damaged parts has been made by the inspector.

The user interface display screen 600 further includes a second data set 620 associated with jobs performed by particular inspectors or estimators. The second datasets 620 is depicted as including a plurality of data fields, illustratively a job ID data field 621, an equipment field 622, an equipment name field 623, a unit code field 624, a driver field 625, a gatekeeper field 626, a gatekeeper time field 627, and estimator field 628 and an estimator time field 629.

Data within these various fields is associated with particular estimators or inspectors. Fields 621-627 are substantially the same as described above with respect to fields 611-617 of the first data set 610. The estimator field 628 may be used to identify the inspector/estimator who inspected equipment. Estimated time field 629 may be used to identify the date/time the equipment was inspected.

Various modifications to the user interface display screen 600 depicted above with respect FIG. 6 will be appreciated to those skilled in the art informed by the teachings herein.

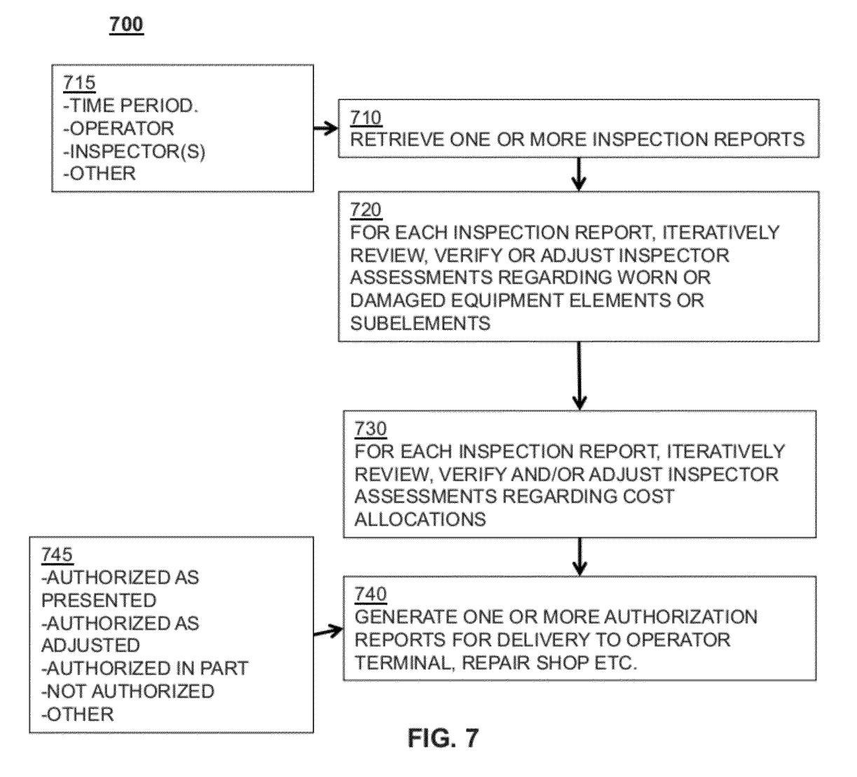

FIG. 7 depicts a flow diagram of a method for validating inspection data. Specifically, FIG. 7 depicts a method 700 suitable for use by a surveyor or adjuster to remotely review inspection reports and rapidly authorized the repair/replacement of worn or damaged elements or sub-elements of inspected equipment. The inspection reports comprise the data, assessment, imagery and/or other information provided by inspectors via a user device during an equipment inspection.

The surveyor or adjuster may validate inspection data reports via a user device operating in a surveyor/adjuster mode or some other computing device. Generally speaking, the method 700 of FIG. 7 enables rapid validation of inspection data to provide thereby an unconditional authorization, conditional authorization or non-authorization to repair/replace worn or damaged parts.

At step 710, one or more inspection reports are retrieved. That is, at step 720 surveyor or adjuster using, illustratively, a tablet device or other device interacting with the services provider retrieves from the provider one or more inspection reports associated with specific inspection job, operators, inspectors and the like. Referring to box 715, the retreat inspection reports may comprise those within a specific time period, associate with a specific operator, associated with one or more specific inspectors or some other grouping of inspection reports.

At step 720, for each inspection report, the method iteratively displays the inspector assessments regarding worn or damaged equipment elements or sub-elements in a manner enabling the surveyor or adjuster to review the assessments, verify that the assessments are accurate and/or adjust the inspector assessments. For example, an adjuster may find that imagery of an element or sub element of inspected equipment is inconsistent with the inspectors assessment. In this case, the adjuster may negate inspectors assessment or modify that assessment (e.g., repair a part rather than replace apart).

At step 730, for each inspection reports, the method iteratively displays the inspector assessments regarding cost allocations associated with inspector determinations of worn or damaged equipment elements or subelements in a manner enabling the surveyor or adjuster to review the assessments, verify that the assessments are accurate and/or adjust the inspector assessments. For example, an adjuster may find that an allocation of cost to an equipment lessor for replacement of a part based upon normal wear and tear of that part is incorrect due to an adjuster determination that the part was damaged by the equipment lessee.

At step 740, one or more authorization reports are generated for delivery to an operator terminal, a repair shop, an insurance company, third party data source and/or some other entity. Referring to box 745, the authorization reports indicate that the repair/replace decisions and related cost allocations in the inspection reports are authorized as presented by the inspector, authorized as adjusted by the adjuster/surveyor, authorized only in part, not authorized and so on.

FIG. 8 depicts a high-level block diagram of a general-purpose computer suitable for use in performing the functions described herein. Specifically, FIG. 8 depicts a high-level block diagram of a general-purpose computer suitable for use in performing the functions described herein. As depicted in FIG. 8, system 800 comprises a processor element 802 (e.g., a CPU), a memory 804, e.g., random access memory (RAM) and/or read only memory (ROM), an RMT management module 805, and various input/output devices 806 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the various processes can be loaded into memory 804 and executed by processor 802 to implement the functions as discussed above. As such the processes (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
for each of a plurality of portions of equipment to be inspected according to a defined sequence, performing the steps of:
displaying, via a display on a portable user device, an image of the equipment portion;
displaying, via said display and in response to user input to said portable user device, one or more elements or sub-elements within said equipment portion;
in the case of user input indicative of one or more damaged elements or sub-elements, displaying a user prompt requesting the user to photograph the one or more damaged elements or sub-elements; and
including, in repair/replace list adapted for propagation to a server, identification and photographs of damaged elements or sub-elements.

2. The method of claim 1, further comprising transmitting said repair/replace list toward said server after all of said equipment portions have been inspected.

3. The method of claim 1, further comprising transmitting said repair/replace list toward said server after each of said equipment portions have been inspected.

4. The method of claim 1, wherein for each of said sequence of equipment portions, said steps further comprise:
displaying a visual tool adapted to enable accurate photographing of said damaged elements or sub-elements.

5. A computer readable medium including software instructions which, when executed by a processer, performs a method, comprising:
for each of a plurality of portions of equipment to be inspected according to a defined sequence, performing the steps of:
displaying, via a display on a portable user device, an image of the equipment portion;
displaying, via said display and in response to user input to said portable user device, one or more elements or sub-elements within said equipment portion;
in the case of user input indicative of one or more damaged elements or sub-elements, displaying a user prompt requesting the user to photograph the one or more damaged elements or sub-elements; and
including, in repair/replace list adapted for propagation to a server, identification and photographs of damaged elements or sub-elements.

6. A computer program product, wherein a computer is operative to process software instructions which adapt the operation of the computer such that computer performs a method, comprising:
for each of a plurality of portions of equipment to be inspected according to a defined sequence, performing the steps of:
displaying, via a display on a portable user device, an image of the equipment portion;
displaying, via said display and in response to user input to said portable user device, one or more elements or sub-elements within said equipment portion;
in the case of user input indicative of one or more damaged elements or sub-elements, displaying a user prompt requesting the user to photograph the one or more damaged elements or sub-elements; and
including, in repair/replace list adapted for propagation to a server, identification and photographs of damaged elements or sub-elements.
